(19) United States
(12) Patent Application Publication
(10) Pub. No.: US 2009/0326940 A1
(43) Pub. Date: Dec. 31, 2009

(54) AUTOMATED VOICE-OPERATED USER SUPPORT

(75) Inventors: Guntbert Markefka, Hannover (DE); Klaus-Dieter Liedtke, Nienburg (DE); Vincente-Manuel Lopez-Monjo, Bad Honnef (DE); Florian Metze, Pittsburgh, PA (US)

Correspondence Address: DARBY & DARBY P.C., P.O. BOX 770, Church Street Station, New York, NY, 10008-0770, US

(73) Assignees: Deutsche Telekom AG, Bonn (DE); Technische Universitaet Berlin, Berlin (DE)

(21) Appl. No.: 12/492,805

(22) Filed: Jun. 26, 2009

(30) Foreign Application Priority Data
Jun. 26, 2008 (EP) 08 15 9111.7

(51) Int. Cl. G10L 15/26; G06F 17/30

(52) U.S. Cl. 704/235; 707/104.1; 707/E17.044; 704/E15.043

(57) ABSTRACT

An information device for voice-operated support of a user includes a storage medium, a knowledge database, a processing unit, an input device, a recording component, a transcription component, and an ontological analysis component. A signal is detected by the input device and stored by the recording component via the processing unit in the storage medium. The signal is transformed into a corresponding text by the transcription component via the processing unit and stored in the storage medium. The ontological analysis component categorizes the text via the processing unit using the knowledge database and processes the text using the categorization and the knowledge database via the processing unit.

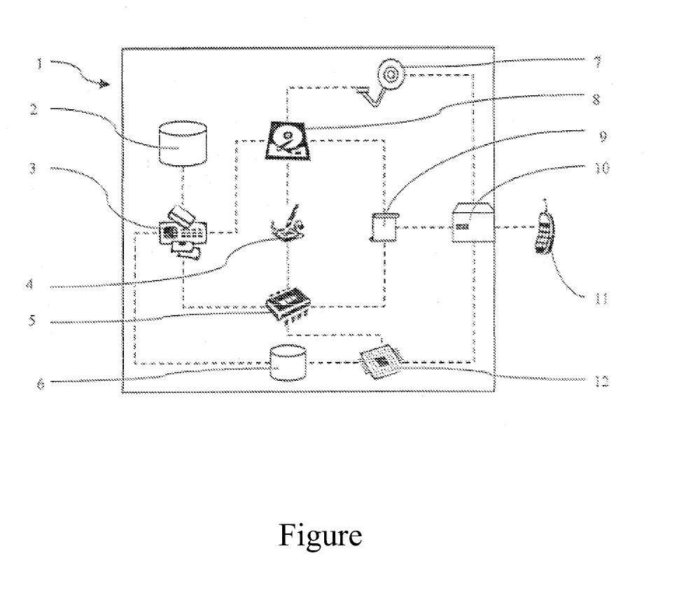

### CROSS REFERENCE TO RELATED APPLICATIONS

Priority is claimed to European Patent Application No. EP 08 15 9111.7, filed Jun. 26, 2008, which is hereby incorporated by reference herein.

### FIELD

The invention relates generally to an information device as well as a method for voice-operated support of a user and a computer program for executing such a method. Specifically, the present invention relates to an information device including a storage medium, a knowledge database, a processing unit, an input device, a recording device and a transcription component, wherein a signal detected by the input device is storable by the recording device via the processing unit in the storage medium and wherein the signal convertible by the transcription component via the processing unit into a corresponding text and storable in the storage medium can be used for voice-operated support of a user.

### BACKGROUND

For the automated support of users, such as, e.g., customers of a company, information devices are nowadays used, which typically process requests of the users via voice portals exhibiting a voice user interface (VUI) for interaction with the users. Here specific business processes of the users of the information device, such as, e.g., a company and in particular telecommunications companies, are often stored in the information devices, through which, in the ideal case, the requests of the users can be finally processed. The interaction with the users is often carried out by the VUI via natural language understanding (NLU), as described for instance in WO 2004/003888 A1.

Although the performance of such information devices improves continuously, e.g., with regard to the amount of stored business processes, the processing speed and/or the interaction with the user, it is nowadays often the case that requests of the users can only be finally processed together with human advisors. At a certain point in processing the customer's request, the users are, e.g., connected by the information device to a suitable advisor. Regarding particularly the support of users in the field of complex issues, e.g., a comprehensive support in the field of telecommunications, a comparatively low amount of requests can be finally processed in an automated manner. Accordingly, a comparatively high number of well-trained advisors has to be provided by the operator to support the users. This can be complex and expensive.

In order to prevent the user from terminating the support before his/her request has been finally processed, it is important that the information device recognizes the right moment to connect the user to a suitable advisor. Terminated supports can lead to annoyed users and possibly have a negative impact on the operator. Nowadays in the automated selection of the appropriate advisor, often the information collected by the support of the user is not or inefficiently evaluated so that many users are not directly connected to the suitable advisor but only indirectly via multiple call forwarding by humans. This can contribute to the annoyance of the users on the one hand and cause a rather great effort in supporting the user on the other hand.

### SUMMARY

It is an aspect of the present invention to provide a (partly) automated, voice-operated support of a user, which is comparatively efficient and cost-effective.

In accordance with an embodiment of the present invention, an information device for voice-operated support of a user is provided. The information device includes a storage medium, a knowledge database, a processing unit, an input device, a recording device, a transcription component, and an ontological analysis component. A signal detected by the input device is recorded and stored by the recording component via the processing unit in the storage medium. The recorded signal is transformed into corresponding text by the transcription component via the processing unit and stored in the storage medium via the processing unit. The ontological analysis component categorizes the text via the processing unit using the knowledge database, and processes the text using the categorization and the knowledge database via the processing unit.

### BRIEF DESCRIPTION OF THE DRAWINGS

The foregoing and other features of the present invention will be more readily apparent from the following detailed description and drawings in which the FIGURE depicts a schematic illustration of an information device according to an embodiment of the invention.

### DETAILED DESCRIPTION

An embodiment of the present invention includes an information device for the voice-operated support of a user comprises a storage medium, a knowledge database, a processing unit, an input device, a recording device and a transcription device. A signal detected by the input device is storable by the recording device via the processing unit in the storage medium and the signal is convertible by the transcription component via the processing unit into a corresponding text and storable in the storage medium. The information device comprises an ontological analysis component by which the text is categorizable with the processing unit using the knowledge database and by which the text can be processed using said categorization and the knowledge database via the processing unit. Processing in this sense comprises initiating an action adapted to the text, like, e.g., generating an automated answer, generating an automated question or connecting to an appropriate advisor for further support of the user.

A further processable text is generated as a work element by the transformation of the signal detected by the input device into a written form and representing the request of the user. Said text can then be further processed by the ontological analysis component, e.g., by carrying out an ontological research in the knowledge database. Information from the line of business of the operator of the information device, for instance from the line of business of a telecommunications company, can be appropriately stored in the knowledge database. Thus, the text can be specifically processed efficiently and in a high quality in order to efficiently support the user with the information device according to the invention. For example, the user can be connected to a specifically chosen advisor who is particularly specialized in the user's request. The user may also be provided with a qualified answer generated automatically, which increases the probability that the user can be finally supported in a fully automated manner.

The input device may comprise a component for acoustically detecting speech and the signal may be a voice signal. The input device can be connected, e.g., to a user terminal, such as a telephone, a microphone or a personal computer equipped with a headset, via any wired or wireless network. The user can then interact with the information device via the user terminal by transmitting spoken information as voice signal to the input device. The input device can then make the voice signal available in a form suitable for further processing. In particular, for example the voice signal can be digitized and stored by the recording device in a predefined digital format. Thus, an efficient processing of the voice signal is possible, which may enhance an efficient operation of the information device.

The information device may comprise a user interaction component for automated operation of a support interaction with the user via the input device. Such a user interaction component, in particular an Interactive Voice Response component (IVR) can be used for additional, parallel or combined support of the user. The IVR can interact with the user, e.g., through single word recognition via natural language understanding (NLU) or Dual Tone Multifrequency Dialing (DTMF). Moreover, at a certain point of the support interaction, e.g., prior to a possible termination detected by the information device, the user can be asked to freely formulate his/her request. This free formulation can then be processed by the information device as signal and edited by the ontological analysis component. The user can thus be connected to a qualified, suitable advisor or get an automatically generated, qualified answer to his/her request.

In order to recognize this certain point of the support interaction, the information device can detect continuously interrupted supports in operation and correlate them with certain features, such as age, gender or a recognized emotion of the user, time, duration of the support, the number of supports or certain keywords. Further, the information device can be configured to be adaptive so that user inputs in the support interaction can be compared with regard to various word and sentence level confidences. The information device can also be configured to predict the probability of a final support of the user with observed values.

The text may be categorizable using the support interaction of the user interaction component by the ontological analysis component via the processing unit and the text can be edited using the support interaction of the user interaction component by the ontological analysis component via the processing unit. The search domain of an ontological search by the ontological analysis component can be restricted by the user inputs in the support interaction. Editing the text can be more efficient using the support interaction by the ontological analysis component and the quality and efficiency of the support of the user can be improved as well.

The information device may comprise a signal generation component for automatically generating the signal using the support interaction of the user interaction component. With such a signal generation component, the signal can be automatically generated and then, after transformation into a text, edited again via the ontological analysis component. Accordingly, the user does not have to transmit or formulate in detail the signal specifically for the ontological analysis, but the user can be supported via IVR as usual and the signal is generated automatically without additional effort on the user's side. The signal which can be, e.g., a simulated longer user statement can be generated for instance from a plurality of shorter user statements input into the user interaction component in the course of the support interaction. Here, e.g., a method for concatenation of the individual user statements and the adaptation of the acoustic properties can be used.

The information device may comprise an output device, wherein the edited text can be synthesized into a voice output, which can be output via the output device, by the transcription component via the processing unit. The user can be supported fully or semi-automatically with such a text-to-speech mechanism. For instance, a response generated by the ontological analysis component to the freely formulated question by the user can be output in the form of speech again to the user.

The information device may comprise a user database, wherein information about the user and information about the edited text are storable in the user database. The users can be assisted more efficiently with such a user database since the stored information can be re-used when repeatedly supporting the same user.

A further aspect of the invention relates to a method for voice-operated support of a user with an information device, comprising the steps of:
(a) detecting a signal with an input device;
(b) storing the detected signal in a storage medium via a processing unit;
(c) transforming the stored signal by a transcription component into a corresponding text via the processing unit;
(d) storing the text in a storage medium via the processing unit, characterised in that the method comprises the steps of:
(e) categorizing the text using a knowledge database by an ontological analysis component via the processing unit;
(f) editing the text using the categorization and knowledge database by the ontological analysis component via the processing unit.

The above steps of the method can also be carried out in a different order. Analogously to the above-described information device, the text can be generated and edited efficiently and in a high quality with such a method for efficiently supporting the user with the information device according to an embodiment of the invention.

The method may comprise the step of the automated operation of a support interaction with the user through a user interaction component via the input device.

The method may comprise the step of automatically generating the signal using the support interaction of the user interaction component, wherein cooperative user inputs of the support interaction are recognized by the support interaction component and used for the automatic generation of the signal. Cooperative user inputs in this sense comprise inputs containing new or specific information of the user. Said inputs are to be differentiated from inputs generated by misdirections of the user interaction component. Thus, the quality of the automatedly generated signal can be increased and the support of the user can be enhanced.

The method may comprise the step of categorizing the text using the support interaction of the user interaction component, wherein, based on a rule, either the categorization of the text using the knowledge database by the ontological analysis component or the categorization of the text using the support interaction of the user interaction component for processing the text by the ontological analysis component is chosen via decision component. The rules concerning this selection can be determined initially, generated automatedly in advance from supports of the information device by training users or generated automatedly in operation from supports of the users.

The method may comprise the step of storing information about the implementation of the method in the knowledge database via the processing unit.

The step of editing the text may comprise the execution of an ontological research in the knowledge database and the generation of an answer. The user can be supplied with a qualified answer generated in response to his/her request by a method form in a specific automated manner. This can increase the probability that the user can be finally supported in a fully automated manner and thus enables an efficient support of the user.

When editing the text, the method may generate at least two variants, which are respectively provided with an indication evaluated by the ontological analysis component via the processing unit for the independent selection by the user. In order to evaluate these indications, e.g., achievable goals and the further information required for achieving these goals are stored in the information device as well as information regarding the support of other users and of advisors. Further, the method can recognize mutually exclusive faulty variants through the use of statistical algorithms. The method may also be construed through the use of statistical algorithms to determine with which granularity a faulty variant can be restricted so that all variants below this granularity are transmitted to the user.

Another aspect of the invention relates to a computer program for executing the above-described method. With such a computer program the methods or parts thereof can be implemented quite easily and efficiently, e.g., in an information device.

The FIGURE shows an embodiment of an information device 1 of the invention comprising a knowledge database 2, a storage medium 8 and a processing unit 5. The information device 1 can be implemented on one or more computers as own electronic switch unit or in another suitable way. The storage medium 8 can be configured, i.e., as hard-disk storage, as random access memory (RAM), as virtual memory on a hard-disk storage, as read-only memory (ROM) or as any other suitable memory. The knowledge database 2 can be implemented in a database management system, which is stored in the storage medium 8 itself or in a further storage medium. The processing unit 5 can be configured as microchip, as a compound of several microchips, as another circuit or as any suitable unit.

The information device 1 comprises an I/O interface 10 as input device and as output device connectable to a user terminal 11. The user terminal 11 can be, e.g., a landline telephone, a cellular phone, a microphone, a computer, a Personal Digital Assistant (PDA) or another suitable device. The I/O interface 10 and the user terminal 11 can be connected via a wired or wireless telephone network such as, e.g., a Public Switched Telephone Network (PSTN), an Integrated Services Digital Network (ISDN), a Global System for Mobile Communications (GSM), a General Packet Radio Service (GPRS), a Universal Mobile Telecommunications System (UMTS) etc., via a wired or wireless computer network such as, e.g., a Local Area Network (LAN), a Wide Area Network (WAN), a Wireless Local Area Network (WLAN), any other suitable connection or any combination of different connections.

In the information device 1 the I/O interface 10 operatively connects an IVR (Interactive Voice Response) component 12 and an IVR database 6 as user interaction component. The IVR database 6 can be implemented in the same database management system like the knowledge database or in another database management system, which can be also stored in the storage medium 8 itself or in another storage medium. Further, the I/O interface 10 operatively connects recording device 9 and a TTS (Text To Speech) component 7 of a transcription component, wherein the transcription component also comprises an STT (Speech To Text) component 4. The information device further comprises an ontological analysis component 3. The IVR component 12, the TTS component 7 and the TST component 4 of the transcription component, the recording device 9 as well as the ontological analysis component 3 can be configured in particular at least partly respectively or arbitrarily combined as a computer program, wherein the computer programs can be stored in the storage medium 8 or in a further storage medium.

In operation the information device 1 can be used in particular as voice portal for the fully automatic or at least semi-automatic customer support, e.g., to support customers of a telecommunications company. Here the information device to support customers is configured to meet the needs of the customers and the operator. If, e.g., the information device is used to support customers of a telecommunications company, the knowledge database 2 and/or the IVR database 6 comprise(s) data from the knowledge domain of the telecommunications company and its customers, which are additionally structured and organised accordingly.

In a possible configuration of the information device 1, a call placed by a customer via the user terminal 11 is received by the information device 1 and connected via the I/O interface 10 to the user interaction component. Here requests are conventionally transmitted to the user from the IVR component 12 via the user terminal 11 and then signals transmitted from the user via the user terminal 11 are detected by the IVR component 12. These signals can be, e.g., DTMF (dual-tone multifrequency dialing) signals, spoken single words or also spoken short sentences. The IVR component 12 analyzes the signals using data stored in the IVR database 6, e.g., by a categorization of the DTMF signal or a categorization via NLU (Natural Language Understanding) and initiates a next support step for supporting the customer, i.e., for instance transmitting a next request for further categorization of the customer's request or outputting a suitable predefined spoken answer in reply to the customer's request. Moreover, at a certain point of the thus generated support interaction, the user can be directly connected to an expert of the operator evaluated on the basis of the executed categorization of the customer request.

In a step of the support interaction, which can be, e.g., already at the very beginning of the support dialogue or prior to a possible termination of the support interaction by the user detected by monitoring devices, the IVR component 12 transmits a demand to the user to freely formulate his/her request. The customer request thus spoken into the user terminal 11 is detected by the I/O interface 10 as spoken signal. The spoken signal is stored by the recording device 9 in the storage component 8 and transformed by the STT component 4 of the transcription component into written text and stored in the storage medium 9 as text. The stored text is then subjected to an ontological research, adapted to the knowledge domain of the operator, by the ontological analysis component 3 with the aid of the knowledge database 2. The result of this ontological research is then used by the ontological analysis component 3 to edit the text.

A corresponding computer program can be used as monitoring device. It can be configured, e.g., to be adaptive by correlating registered terminations of the support interaction with certain features, such as the age of the user, the gender of the user, the time, the duration of the support interaction, the number of support interactions per user, certain keywords, a hypothesis of the voice recognition, a confidence of the voice recognition hypothesis or a recognizable emotion of the user. The computer program can also be configured to keep the user connected until the processed text is available to the ontological analysis component 3.

The processing by the ontological analysis component 3 can be carried out for instance by specifically categorizing the customer request or the text, e.g., the customer request can be assigned to a business process of the operator. The thus generated specific categorization of the customer request can be used, e.g., as described above either for outputting a suitable predefined spoken answer to the customer request via the IVR component 12 or for directly connecting the user to an expert of the operator evaluated as suitable adviser through the executed specific categorization of the customer request. In particular the processing by the ontological analysis component 3 can be also conducted such that a specific answer according to the customer request is generated automatically by the knowledge database 2. The thus generated specific answer to the customer request can be synthesized again via the TTS component 7 of the transcription component to a spoken signal, which is then transmitted via the I/O interface 10 and the user terminal 11 to the user. It is possible via the automated generation of the specific answer by the ontological analysis component 3 to specifically answer the customer request without predefining possible answers. This enables a synchronous fully automatic support of the customer request at a relatively high quality level. Furthermore, the probability of a termination of the support interaction by the user can be minimized.

In another possible configuration of the information device 1, a customer call made via the user terminal 11 is received by the information device 1 and connected to the user interaction component via the I/O interface 10. Again conventionally, requests are transmitted to the user by the IVR component 12 via the user terminal 11 and signals transmitted by the user via the user terminal 11 are detected by the information device 1. The signals are likewise stored by the recording device 9 in the storage medium 8. The STT component 4 of the transcription component generates in an automated manner a written text from the stored signals and stores it in the storage medium 8. This automated generation of the written text can be effected, e.g., by sliding concatenation of individual statements of the user and adaptations of the acoustic properties. It can also be effected, e.g., by individual recognition of a partial statement and symbolic concatenation. As described above, the stored text is then subjected to an ontological research, adapted to the knowledge domain of the operator, by the ontological analysis component 3 with the help of the knowledge database 2 and processed according to the further use.

In further configurations of the information device 1 or in further configurations of the above-described configurations of the information device 1, the signals of the user can be further processed parallel both by the user interaction component and the transcription component together with the ontological analysis component 3. Thus, the information device 1 can be used relatively efficiently. Moreover, the IVR component 12 and/or the ontological analysis component 3 can transmit to the user a variety of answers to the customer request. Here in addition an information for transmittal to the user can be generated through a text processed by the ontological analysis component 3, thus enabling the users to restrict their customer requests themselves.

Further, information about a support interaction or an executed processing by the ontological analysis component 3 in the knowledge database 2 and/or a user database can be stored and reused for a future support of the same user as well as for the statistical evaluation by the operator. This can be effected, e.g., by storing, i.e., the position in the structure of the data of the knowledge database 2 and the version of data of the knowledge database 2. It can also be effected by extracting and storing certain keywords of the support interaction. Thus, a user can be supported several times by the information device 1 in a relatively efficient manner, the knowledge database 2 can be further developed in an automated way and the operator can be informed about the efficiency of the support interactions conducted via the information device.

Although the invention is illustrated and described in detail with the FIGURE and the corresponding description, said illustration and detailed description is to be regarded as illustrative and exemplary and not as being restrictive to the invention. Naturally, experts can perform amendments and modifications without abandoning the scope and spirit of the following claims. In particular the invention also comprises embodiments with any combinations of features, which are mentioned or shown above or in the following with regard to different embodiments.

The invention also comprises individual features of the FIGURE even if they are shown in connection with other features and/or are not mentioned above or in the following.

Furthermore, the expression “comprise” and derivations thereof do not exclude other elements or steps. Likewise the indefinite article “a” and derivations thereof do not exclude a plurality. The functions of several features mentioned in the claims can be fulfilled by a single unit. A computer program can be stored on a suitable medium and/or distributed, e.g., on an optical storage medium or a fixed medium, which is provided together with or as part of another hardware. It can also be distributed in another form, e.g., via the Internet or other wired or wireless telecommunications systems. All reference signs in the claims are to be regarded as being not restrictive to the scope of the claims.

What is claimed is:

1: An information device for voice-operated support of a user, the information device comprising:
a processing unit;
a storage medium;
a knowledge database;
an input device operative to detect a signal;
a recording device operative to record the detected signal and store the recorded signal in the storage medium via the processing unit;
a transcription component operative to transform the recorded signal into corresponding text and store the corresponding text in the storage medium via the processing unit; and
an ontological analysis component operative, via the processing unit, to categorize the corresponding text using the knowledge database and to process the corresponding text using the categorization and the knowledge database.

2: The information device according to claim 1, wherein the input device comprises an acoustic receiver and wherein the signal includes a voice signal.

3: The information device according to claim 1, further comprising a user interaction component operative to perform an automated support interaction with the user via the input device.

4: The information device according to claim 3, wherein the ontological analysis component is operative, via the processing unit, to categorize and process the corresponding text using the automated support interaction.

5: The information device according to claim 3, further comprising a signal generator operative to generate the signal using the automated support interaction.

6: The information device according to claim 1, further comprising an output device, and wherein the transcription component is operative to synthesize the processed text into a voice output via the processing unit, and wherein the output device is operative to output the voice output.

7: The information device according claim 1, further comprising a user database operative to store information about the user and information about the processed corresponding text.

8: A method for voice-operated support of a user with an information device, the method comprising the following steps:
detecting a signal with an input device;
storing the detected signal in a storage medium via a processing unit;
transforming, by a transcription component, the stored signal into a corresponding text via the processing unit;
storing the corresponding text in the storage medium via the processing unit;
categorizing, by an ontological analysis component using a knowledge database, the corresponding text via the processing unit; and
processing, by the ontological analysis component, using the categorization and the knowledge database, the corresponding text via the processing unit.

9: The method according to claim 8, further comprising the step of performing, by a user interaction component, an automated support interaction with the user via the input device.

10: The method according to claim 9 further comprising the steps of:
recognizing, by the user interaction component, cooperative user inputs of the automated support interaction; and
automatically generating the signal using the recognized cooperative user inputs of the automated support interaction.

11: The method according to claim 9, further comprising the steps of:
categorizing the corresponding text using the automated support interaction; and
choosing, based on a rule, either the categorization by the ontological analysis component or the categorization using the automated support interaction.

12: The method according to claim 8, further comprising the step of storing, in a knowledge database via the processing unit, information about an implementation of at least one of the detecting, storing, categorizing, and processing steps.

13: The method according to claim 8, wherein the step of processing the corresponding text using the categorization via the processing unit comprises conducting an ontological research in the knowledge database and generating an answer.

14: The method according to claim 8, wherein the processing step comprises generating and evaluating at least two variants and further comprising the step of providing the at least two variants to the user for selection by the user.

15: A computer-readable medium having computer-executable instructions for performing a method comprising the steps of:
detecting a signal with an input device;
storing the detected signal in a storage medium via a processing unit;
transforming, by a transcription component, the stored signal into a corresponding text via the processing unit;
storing the corresponding text in the storage medium via the processing unit;
categorizing, by an ontological analysis component using a knowledge database, the corresponding text via the processing unit; and
processing, by the ontological analysis component, using the categorization and the knowledge database, the corresponding text via the processing unit.
